(19) United States
(12) Patent Application Publication
(10) Pub. No.: US 2008/0178125 A1
(43) Pub. Date: Jul. 24, 2008

(54) Providing dynamic content in a user interface in an application

(75) Inventors: John E. Elsbree, Bellevue, WA (US); William H. Linzbach, Sammamish, WA (US); David E. Fleishman, Snoqualmie, WA (US); Marc S. Oshiro, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/656,632

(22) Filed: Jan. 23, 2007

(51) Int. Cl. G06F 3/048

(52) U.S. Cl. 715/862

(57) ABSTRACT

Providing dynamic content in a user interface page in an application is disclosed. The user interface page is rendered in the application, in which the user interface page includes at lease one menu items. Responsive to a selection of a menu item, at least one tile corresponding to the selected menu item is rendered. Responsive to an interaction with a tile, dynamic content is rendered within the tile in the application.

### BACKGROUND

The convergence of computing and entertainment continues to provide new content and options for consumers. For example, cable subscribers can now access cable television programs and video-on-demand content (VOD) through their set-top boxes. In one offering, video-on-demand service allows a user to select a program for viewing from a library of programs, wherein all of the programs are available at any time and can be paused, saved, reviewed, etc. (as opposed to a cable television program that is only available at a scheduled time and duration). Other sources of content may also exist, including content from a media library, an Internet Protocol (IP) stream, a Web site, etc.

Consumers and content providers can find great benefit in the availability of content from so many different types of sources. For example, a consumer can view a rerun episode of a cable television program and then search for and view a subsequent episode of the same program over VOD or some other content providing channel. For their part, content providers can keep people “tuned in” with a wider assortment of content and content types.

In providing a user interface to access such a wide variety of content, certain media applications provide a discovery interface. In one existing example, a discovery interface takes the form of an Electronic Programming Guide (EPG). However, the available content, and more importantly, the ways in which to access such content may need to change dramatically overtime. Existing EPGs fail to adequately accommodate changes to the user interface application pages used to access the ever changing content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology, a method and system for providing dynamic content in a user interface page in an application, are disclosed. In one embodiment, the user interface page is rendered in the application, in which the user interface page includes at least one menu item. Responsive to a selection of a menu item, at least one tile corresponding to the selected menu item is rendered. Responsive to an interaction with a tile, dynamic content is rendered within the tile in the application.

### DESCRIPTION OF THE DRAWINGS

The accompanying drawings, which are incorporated in and form a part of this specification, illustrate embodiments of the technology for providing dynamic content in a user interface page in an application, together with the description, serve to explain principles discussed below:

FIG. 1 illustrates an example system for presenting discovery data and applications in a customizable discovery interface in accordance with an embodiment of the present technology.

FIG. 2 illustrates an example menu within a customizable discovery interface in accordance with an embodiment of the present technology.

FIG. 3 illustrates an example application page that can be triggered by a selection of an offering tile in accordance with an embodiment of the present technology.

FIG. 4 illustrates an example content management and delivery system in accordance with an embodiment of the present technology.

FIG. 5 illustrates an architecture for an example media application in accordance with an embodiment of the present technology.

FIG. 6 illustrates example operations for customizing applications in a discovery interface in accordance with an embodiment of the present technology.

FIG. 7 illustrates example operations for providing dynamic content in a user interface page in an application in accordance with an embodiment of the present technology.

FIG. 8 illustrates an example system that may be useful in implementing the described technology in accordance with an embodiment of the present technology.

The drawings referred to in this description should be understood as not being drawn to scale except where specifically noted.

### DETAILED DESCRIPTION

Reference will now be made in detail to embodiments of the present technology for providing dynamic content in a user interface page in an application, examples of which are illustrated in the accompanying drawings. While embodiments of the technology for providing dynamic content in a user interface page in an application will be described in conjunction with various embodiments, it will be understood that they are not intended to limit the present technology for providing dynamic content in a user interface page in an application to these embodiments. On the contrary, embodiments of the present technology for providing dynamic content in a user interface page in an application is intended to cover alternatives, modifications and equivalents, which may be included within the spirit and scope the various embodiments as defined by the appended claims.

Furthermore, in the following detailed description, numerous specific details are set forth in order to provide a thorough understanding of embodiments of the present technology for providing dynamic content in a user interface page in an application. However, the present technology for providing dynamic content in a user interface page in an application may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “rendering”, “launching”, “accessing”, “extracting”, “receiving”, “displaying”, “selecting”, “presenting”, “identifying”, “placing”, “hovering” and “providing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for providing dynamic content in a user interface page in an application is also well suited to the use of other computer systems such as, for example, optical and mechanical computers. Additionally, it should be understood that in embodiments of the present technology for providing dynamic content in a user interface page in an application, one or more of the steps can be performed manually.

### Overview

As an overview, in one embodiment, the present technology provides a method for providing dynamic content in a user interface page in an application. That is, instead of requiring a user to access an application to render dynamic content, such as an audio file or a video file, embodiments of the present technology provide dynamic content in a user interface page in a media application. In one embodiment, the user interface page is a Start Menu page, such that the dynamic content is rendered directly in the Start Menu page. In so doing, the dynamic content is presented without requiring a user to leave the Start Menu.

In one embodiment, the present technology provides dynamic content in a user interface page in a media application. In one embodiment, where the user interface page is a Start Menu page, in response to a user selecting a menu item, a plurality of tiles for performing various actions, such as launching an application page or launching an application for rendering media content, are rendered. In response to an interaction with a tile, such as hovering a cursor over the tile, dynamic content associated with the tile is rendered within the tile. For example, a tile may include a static image of a movie poster, and, in response to interacting with the tile, a video clip of the movie identified in the poster is rendered within the tile itself. Accordingly, embodiments of the present technology provide dynamic content in a user interface page without accessing another application page. Moreover, embodiments of the present technology provide dynamic content for enticing a user to select the associated tile for requesting additional information related to the tile.

The term dynamic content refers to any content that changes appearance over time. In various embodiments, dynamic content includes, but is not limited to audio content, video content, and audio/video content. For example, dynamic content can include without limitations: movies, movie trailers, commercial advertisements, animation, television programming, music videos, or other dynamic presentations.

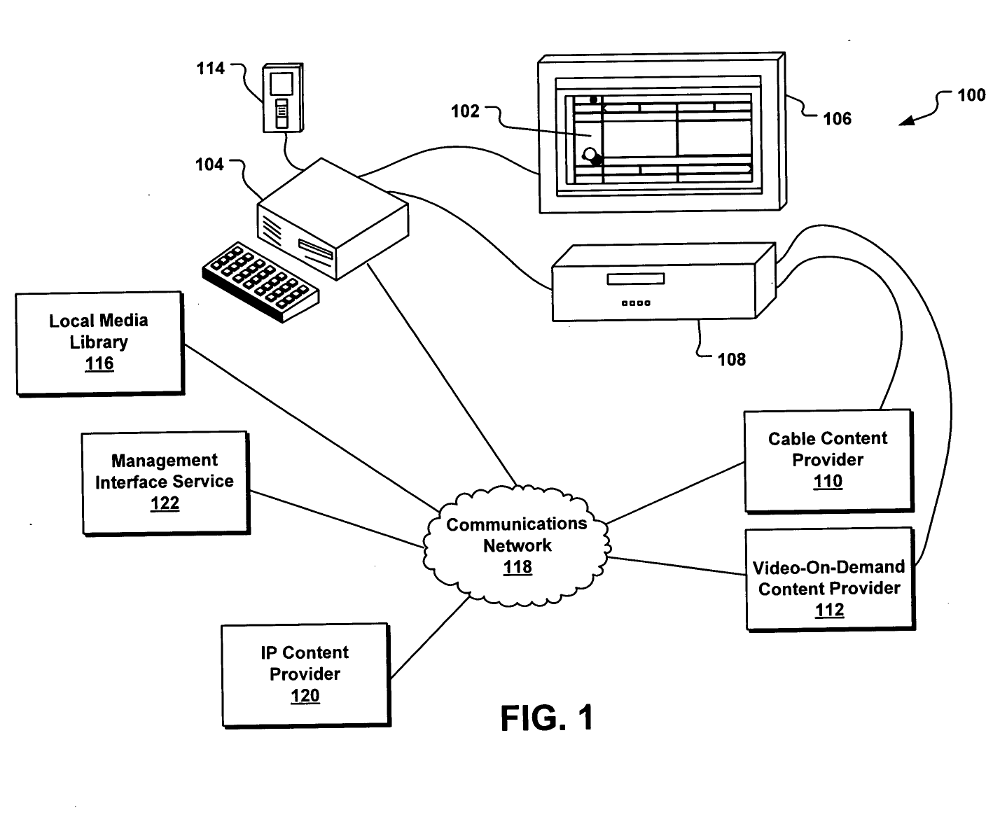

FIG. 1 illustrates an example system 100 for presenting discovery data and applications in a customizable discovery interface 102. A user's computing system 104 is coupled to a display device 106, which is capable of presenting the customizable discovery interface 102. The computing system 104 is also coupled to a tuner device 108 (e.g., a set-top box or a tuner card internal to the computing device), which communicates with a cable content provider 110 and a video-on-demand content provider 112. It should be understood that the cable content provider 110 and the video-on-demand content provider 112 may be represented by the same entity. Furthermore, content providers that compete with the cable providers, such as satellite services and airwave-based broadcast television stations, may also be supported in a similar manner. Content providers for other media, such as satellite radio, broadcast radio, etc., may also be supported through computing system 104.

In one embodiment, the computing system 104 executes a media application that manages the user's access to media content, whether available locally or remotely. For example, the user can use his or her computing system 104 to control a portable media player 114, the tuner device 108, a local media library 116, and other content available from discrete devices or over a communications network 118. Examples of the control a user may apply can include without limitations transferring content between a portable media player 114 and a local media library 116, scheduling the recording of a cable television program to a hard disk in the computing system 104, downloading IP content (such as a video or song) from an IP content provider 120.

In one embodiment, the media application also provides the discovery interface 102 on a display device 106 (e.g., a monitor or television) coupled to the computing device 104. Discovery data is obtained through a media information service 122 that collects program information about content from a variety of sources. The media information service 122 maps data from a variety of sources to one or more consistent schema, enabling a consistent discovery experience, and associates content from different sources. The discovery interface 102 can be represented by an on-screen guide, such as an electronic program guide (EPG), although various monikers may be used in other embodiments, including without limitation interactive program guide (IPG) and electronic service guide (ESG). The discovery interface 102 presents an on-screen guide to the available content (e.g., broadcast content, such as scheduled cable television programs, and non-broadcast content, such as available IP content, locally stored media, etc.) in which broadcast content and non-broadcast content are shown together via virtual channels of the unified discovery interface.

In one embodiment, the discovery interface 102 provides a graphical user interface that can display program titles and other descriptive information (collectively “discovery data”), such as a summary, actors' names and bios, directors' names and bios, year of production, etc. In one embodiment, the information is displayed on a grid with the option to select more information on each program, although other formats are also contemplated. Channel identifiers pertaining to the scheduled cable programs, the program start and end times, genres, thumbnail images, and other descriptive metadata can also be presented within the discovery interface 102. Radio and song information may offer other information, such as artist, album, album cover graphics, and track title information. The discovery interface 102 allows the user to browse program summaries; search by genre, channel, etc.; and obtain immediate access to the selected content, reminders, and parental control functions. If the computing device 104 is so configured or so connected, a discovery interface 102 can provide control for scheduled recording of programs.

A user can use the discovery interface 102 to navigate, select, and discover content by a variety of parameters, including time, title, channel, genre, cost, actors, directors, sources, relationships to other content, etc. Navigation can be accomplished through the media application by a variety of input devices, such as a remote control, a keyboard, and a mouse. In one embodiment, for example, the user can navigate through the discovery interface 102 and display information about scheduled cable programs, video-on-demand programs, and associated IP content within a single presentation frame. By navigating through the discovery interface 102, the user can manipulate and obtain more information about a current program or about other programs available through the discovery interface 102. For example, when the computing device 104 is connected to cable content provider 110, the user can to plan his or her viewing schedule, learn about the actors of available programs, and record cable programs to a hard disk in the computer device 104 for later viewing.

In one embodiment, a package can be downloaded to the computing system 104 in order to customize the data and applications available to the user through the discovery interface 102. The package is typically downloaded from the management interface service 122, but packages may be available from the local (or remote) media library 116 or from various content providers, such as content providers 110, 112, and 120. A package may include without limitation images, dynamic content, audio content, video content, audio/video content, listings of available content, text, markup language files, internal and external links used to present a customizable discovery interface to a user. In one embodiment, one or more menus of the discovery interface 102 may be customized with new images, text, functionality, selections, endpoints, etc. In one embodiment, one or more tiles associated with a menu item of the discovery interface 102 may be customized with new images, dynamic content, text, functionality, selections, endpoints, etc. In another embodiment, individual application pages that are referenced from a menu or other selection may be customized.

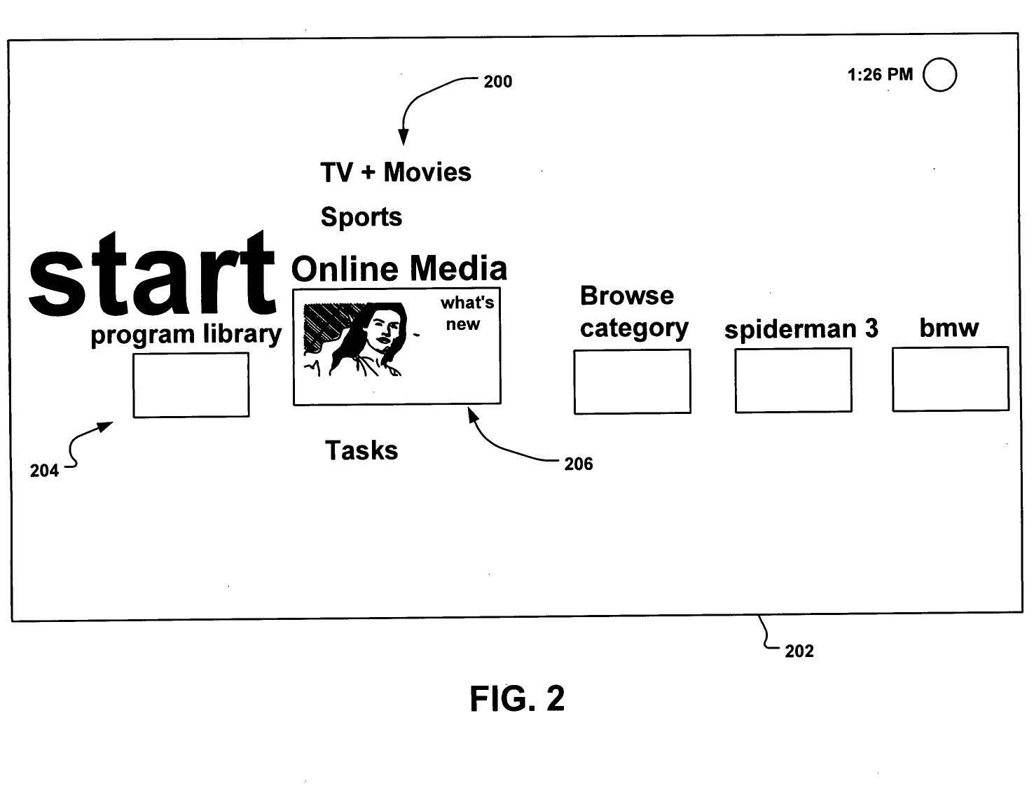

FIG. 2 illustrates an example menu 200 within a customizable discovery interface 202. The menu 200 may include built-in menu items as well as customized menu items. Vertically menu items provide access to categories of offerings (e.g., “TV+Movies”, “Sports”, “Online Media”, etc.). Within the selected menu item (e.g., “Online Media”), several offerings are provided in an offering strip 204. By interacting with one of the offering tiles (e.g., tile 206), a user can cause dynamic content to be rendered within the tile without launching an application page or another user interface page. In one embodiment, a user interacts with a tile by placing (e.g., hovering) a cursor controlled by a user interface interaction device (e.g., a mouse) over the tile. In another embodiment, a user interacts with a tile by placing the cursor over the tile and pressing a button (e.g., clicking) on the user interface interaction device.

In one embodiment, by selecting one of the offering tiles (such as tile 206), a user can launch an application page or user interface page that provides functionality for the offering. In one embodiment, the selection of the tile is determined by detecting a second interaction with the tile. For example, a user may select tile 206 to launch an application page that allows the user to browse and select various categories of online media content. In one embodiment, where a user interacts with a tile by placing a cursor controlled by a user interface interaction device over the tile, a user selects the tile by placing the cursor over the tile and pressing a button on the user interface interaction device. In another embodiment, where a user interacts with a tile by placing the cursor over the tile and pressing a button on the user interface interaction device, a user selects the tile by placing the cursor over the tile and pressing the button on the user interface interaction device twice (e.g., double-clicking). It should be appreciated that different ways of interacting with and selecting a tile may be implemented according to various embodiments of the present technology, and that embodiments of the present technology are not limited to the described embodiments.

In one embodiment, the start menu is represented internally by a markup language file that specifies user interface having a set menu items and offering tiles. A user interface (UI) framework processes the start menu markup and renders the start menu on the display accordingly. One or more of the offering tiles may be built into the media application executing on the computing system. For such built-in tiles, the start menu markup merely has statically defined links to built-in application pages. One or more of the offering tiles may also be customizable. For these tiles, a placeholder exists in the start menu markup, such that if resources have been downloaded for a specific placeholder, the offering tile is rendered for that placeholder. In one embodiment, resources for an offering tile include dynamic content for rendering within the tile in the start menu.

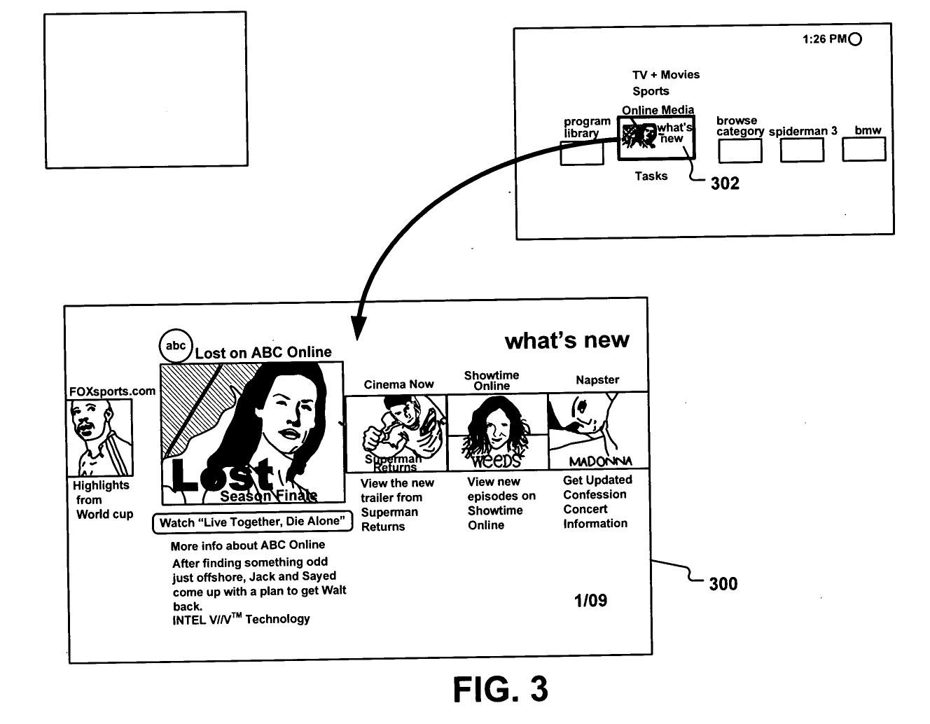

FIG. 3 illustrates an example application page 300 that can be triggered by a selection of an offering tile 302. The application page 300 may be a built-in application page, which uses markup that is built-in into the media application on the computing system; a customized application page, which uses markup downloaded in a package from a remote source; or a Web application page, which is retrieved upon selection from a Web source. Each tile in the application page can further invoke other built-in, customized, or Web application pages.

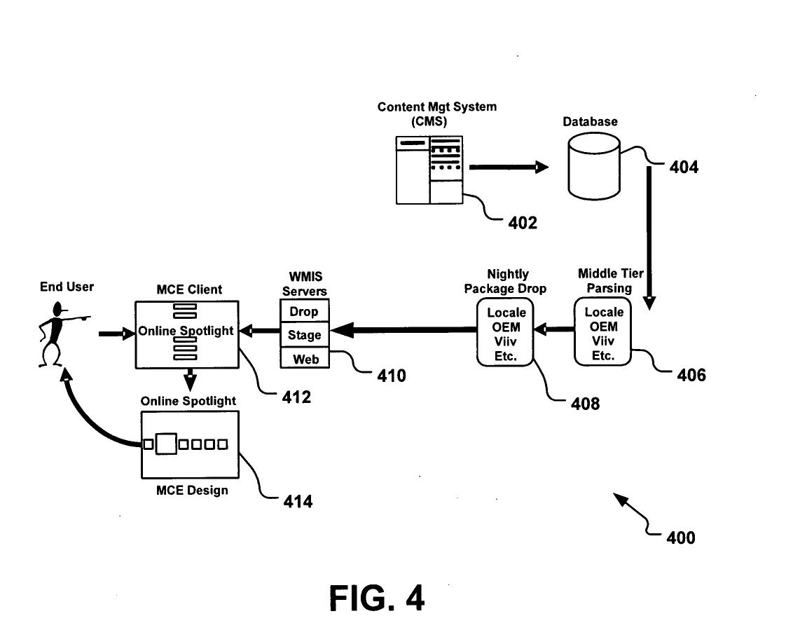

FIG. 4 illustrates an example content management and delivery system 400. A content management system 402 stores media data, including without limitation one or more of program listings, content, customizing packages, parental ratings, preferences, and other parameters, into a database 404. A middle tier parsing module 406 extracts package based on predefined filtering parameters, including geographical locale, OEM relationship of the equipment, system capabilities, user preferences and characteristics, etc. A package drop module 408 periodically uploads selected packages to an information server 410. Drop refers to the internal location where a package is stored for the delivery service to pickup. Stage refers to a testing location where a package can be downloaded and verified. Web refers to the final location where customers will have the package delivered to them. The information server 410 downloads the packages to a media application on a client computing system (e.g., screenshot icon 412 represents a start menu and screenshot icon 414 represents an application page).

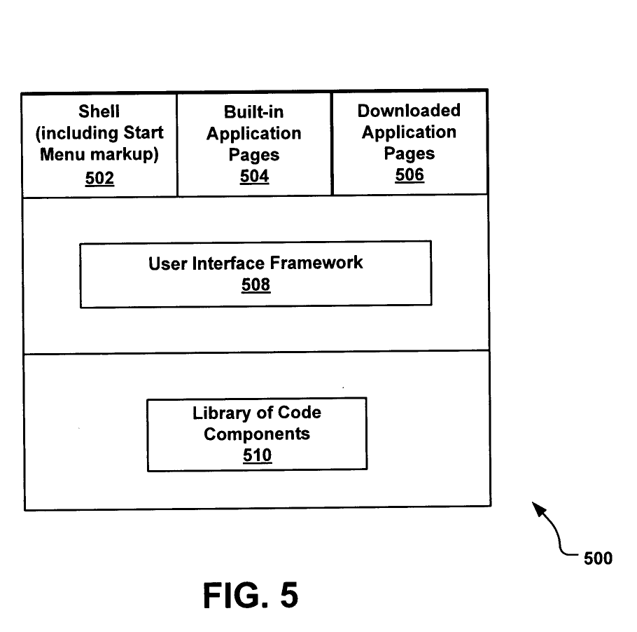

FIG. 5 illustrates an architecture 500 for an example media application, although it should be understood that a similar architecture may be employed in non-media applications. A shell 502 represents a core user interface module of the media application, including the start menu markup, resources, and other structural aspects of the media application.

Built-in application pages 504 represent applications that are incorporated into the distribution of the media application, including markup and resources for individual applications accessible through the start menu and other offering tiles of the media application. Downloaded application pages 506 represent applications that have been downloaded in package form, including markup and resources of customized applications within the media application. Such packages are typically downloaded to the computer system on which the media application executes during expected idle periods (e.g., overnight).

A user interface framework 508 processes the markups of the shell 502, the built-in application pages 504, and the downloaded application pages 506. As for the shell 502, the user interface framework 508 parses the start menu markup, for example, and renders the start menu defined by the markup. In the cases of both built-in application pages 504 and downloaded application pages 506, when the appropriate application is triggered (e.g., by activation of an offering tile by the user), the user interface framework 508 ingests the markup language of the application pages referenced by the trigger and renders the application page defined by the markup.

The markup for application pages 504 and 506 and the shell 502 can reference code in a library 510 of code components. These code components provide functionality, such as manipulating and filtering lists of tables of content metadata, initiating and controlling playback of media content, and interacting with the operating system, etc. The markup references a specific code component and the user interface framework 508 includes the functionality to execute the code in the context of the current user interface.

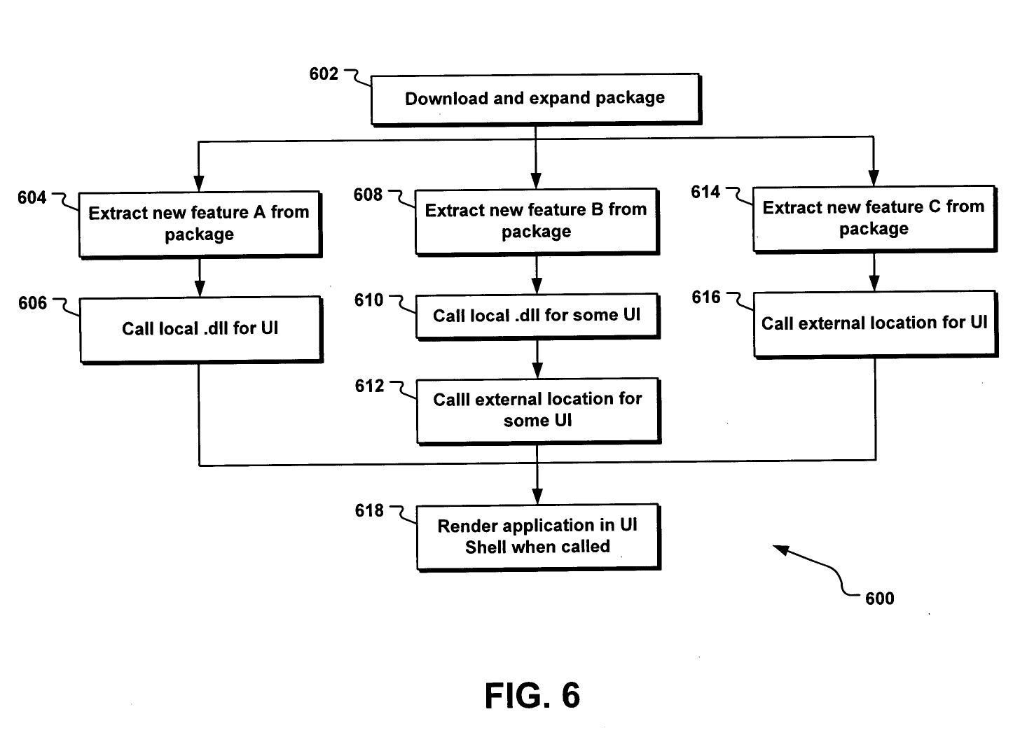

FIG. 6 illustrates example operations 600 for customizing applications in a discovery interface. A downloading operation 602 downloads an application package, which may include markup, images, text, and other resources, received via a communications network (e.g., via a Web service). An example package definition is provided below:

| | |
|---|---|
| #include <winver.h> | |
| #include <ntverp.h> | |
| #define VER_FILETYPE | VFT_DLL |
| #define VER_FILESUBTYPE | VFT2_UNKNOWN |

| | |
|---|---|
| #define VER_FILEDESCRIPTION_STR | “Media Center NetTV Resources” |
| #define VER_INTERNALNAME_STR | “NetTVResources.d11\0” |
| #define VER_ORIGINALFILENAME_STR | “NetTVResources.d11” |

```
#include “common.ver”
//
// Strings
//
STRINGTABLE
BEGIN
// Labels and links that correspond to various items on the Start menu.
// First string in each pair is the label to display on-screen.
// Second string in each pair is either the name of a markup resource
// contained in this package, or the URL of a Media Center markup page
// to be retrieved from the Internet.
    // Online Media section, slot 1
    1011  “what's new”
    1012  “WhatsNew.mcml”
    // Online Media section, slot 2
    1021  “explore”
    1022  “BrowseCategories.mcml”
    // Online Media section, slot 3
    1031  “new product”
    1032  “http://www.northwindtraders.com/mce/ productoffer.mcml”
    // TV section, “More TV” slot
    2011  “more tv”
    2012  “BrowseCategories.mcml#MoreTV”
    // Music section, “More Music” slot
    2031  “more music”
    2032  “BrowseCategories.mcml#MoreMusic”
    // Sports section, “More Sports” slot
    2051  “more sports”
    2052  “BrowseCategories.mcml#MoreNews”
END
//
// MCML resources
//
// Markup resources contained within this package. Each resource
// describes a page of UI, or a component of a page.
```

| | | |
|---|---|---|
| WhatsNew.mcml | RCDATA | “Mcml\\WhatsNew.mcml” |
| BrowseCategories.mcml | RCDATA | |
| “Mcml\\BrowseCategories.mcml” | | |
| MoreLinks.mcml | RCDATA | “Mcml\\MoreLinks.mcml” |
| BrowsePage.mcml | RCDATA | “Mcml\\BrowsePage.mcml” |
| BrowseDetails.mcml | RCDATA | |
| “Mcml\\BrowseDetails.mcml” | | |
| GalleryItem.mcml | RCDATA | |
| “Mcml\\GalleryItem.mcml” | | |
| // | | |
| // PNG resources | | |
| // | | |

// Bitmap images for the items on the Start menu. Each item has two images,
// to represent the item in its non-focused and focused states.
// Online Spotlight, slot 1

| | |
|---|---|
| StartMenu.QuickLink.Spotlight.1.NoFocus.png | RCDATA |
| “Png\\StartMenu.QuickLink.WhatsNew.NoFocus.png” | |
| StartMenu.QuickLink.Spotlight.1.Focus.png | RCDATA |
| “Png\\StartMenu.QuickLink.WhatsNew.Focus.png” | |
| // Online Spotlight, slot 2 | |
| StartMenu.QuickLink.Spotlight.2.NoFocus.png | RCDATA |
| “Png\\StartMenu.QuickLink.Discover.NoFocus.png” | |
| StartMenu.QuickLink.Spotlight.2.Focus.png | RCDATA |
| “Png\\StartMenu.QuickLink.Discover.Focus.png” | |
| // Online Spotlight, slot 3 | |
| StartMenu.QuickLink.Spotlight.2.NoFocus.png | RCDATA |
| “Png\\StartMenu.QuickLink.NorthwindTraders.NoFocus.png” | |
| StartMenu.QuickLink.Spotlight.2.Focus.png | RCDATA |
| “Png\\StartMenu.QuickLink.NorthwindTraders.Focus.png” | |
| // TV section, “More TV” slot | |
| StartMenu.QuickLink.MoreTV.NoFocus.png | RCDATA |
| “Png\\StartMenu.QuickLink.MoreTV.NoFocus.png” | |
| StartMenu.QuickLink.MoreTV.Focus.png | RCDATA |
| “Png\\StartMenu.QuickLink.MoreTV.Focus.png” | |
| // Music section, “More Music” slot | |
| StartMenu.QuickLink.MoreMusic.NoFocus.png | RCDATA |
| “Png\\StartMenu.QuickLink.MoreMusic.NoFocus.png” | |
| StartMenu.QuickLink.MoreMusic.Focus.png | RCDATA |
| “Png\\StartMenu.QuickLink.MoreMusic.Focus.png” | |
| // Sports section, “More Sports” slot | |
| StartMenu.QuickLink.MoreSports.NoFocus.png | RCDATA |
| “Png\\StartMenu.QuickLink.MoreSports.NoFocus.png” | |
| StartMenu.QuickLink.MoreSports.Focus.png | RCDATA |
| “Png\\StartMenu.QuickLink.MoreSports.Focus.png” | |

// Other bitmap images used by the markup resources in this package.
// Partner images
9.gif RCDATA “Png\\9.gif”
26.gif RCDATA “Png\\26.gif”
42.gif RCDATA “Png\\42.gif”
...

Each resource is associated with a resource identifier (ID). Based on the markup in the current page or menu and the user's current selection from that page or menu, one of three features can be selected: A, B, and C (in this example).

If feature A is selected, an extraction operation 604 extracts from the package the markup for an application page (identified by an application page identifier or AppID) and the resources cited by that markup, if any. Also, if specified in the markup, a calling operation 606 calls to a local dynamic link library of a locally resident library of code components to provide desired functionality and/or resources (e.g., based on an identifier, pathname or address).

If feature B is selected, an extraction operation 608 extracts from the package the markup for an application page (identified by an application page identifier or AppID) and the resources cited by that markup, if any. Also, if specified in the markup, a calling operation 610 calls to a local dynamic link library of a locally resident library of code components to provide desired functionality and/or resources (e.g., based on an identifier, pathname or address). Furthermore, if specified in the markup, another calling operation 612 calls to an external location (e.g., on the Web) to provide desired functionality and/or resources (e.g., based on an identifier, pathname or address).

If feature C is selected, an extraction operation 614 extracts the URL encoded in the application page identifier, if any. Also, if specified in the markup, a calling operation 616 calls to an external location (e.g., on the Web) to provide desired functionality and/or resources (e.g., based on an identifier, pathname or address).

When the user interface frame work has gathered the specified functionality and/or resources, a rendering operation 618 renders the application page in the user interface shell of the media application.

### Operation

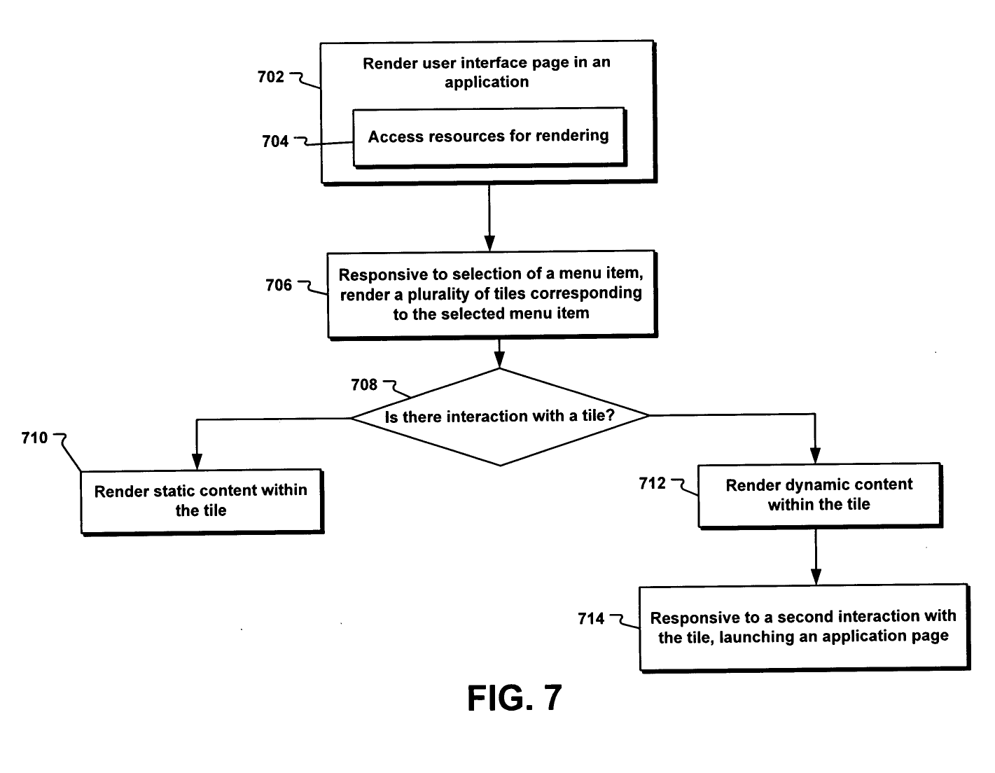

With reference now to FIG. 7, a flowchart 700 of operations performed in accordance with one embodiment of the present technology for providing dynamic content in a user interface in an application is shown. Embodiments of the present technology provide a method of rendering dynamic content directly in a graphical user interface, without accessing additional application pages are user interface pages. Moreover, embodiments of the present technology provide dynamic content for enticing a user to request additional information related to the dynamic content.

Referring now to 702 of FIG. 7 and FIG. 2, a user interface page is rendered in an application. The user interface page includes at least one menu item. In one embodiment, the user interface page includes a plurality of menu items. As shown in FIG. 2, example menu items of menu 200 within customizable discovery interface 202 include “TV+Movies”, “Sports”, “Online Media” and “Tasks”. It should be appreciated that embodiments of the present technology are not limited to the example menu items of FIG. 2. In one embodiment, the user interface page is displayed on a display.

In one embodiment, as shown at 704 of FIG. 7, resources for rendering are accessed. In one embodiment, the resources include dynamic content for rendering. FIG. 6 described above illustrates example operations 600 for customizing applications in a discovery interface. A downloading operation 602 downloads an application package, which may include markup, images, text, and other resources, received via a communications network (e.g., via a Web service).

In one embodiment, a local resource including dynamic content is accessed for rendering within a user interface page in an application. In one embodiment, the local resource is accessed according to calling operation 606 of FIG. 6. In another embodiment, a resource locator identifying an external location including dynamic content is extracted, e.g., according to extraction operation 614 of FIG. 6. The external location is then accessed, e.g., according to calling operation 616 of FIG. 6. In another embodiment, a combination of a local resource and an external location includes dynamic content. In one embodiment, the local resource is accessed, e.g., according to calling operation 610 of FIG. 6, and the external location is accessed, e.g., according to calling operation 612 of FIG. 6.

At 706 of FIG. 7, responsive to a selection of a menu item, a plurality of tiles corresponding to the selected menu item is rendered. Referring to FIG. 2, menu item “Online Media” is shown as the selected menu item. Offering strip 204, corresponding to menu item “Online Media” is rendered. Offering strip 204 includes a plurality of tiles, including “program library”, “what's new”, “browse category”, “spiderman 3”, and “bmw”. It should be appreciated that embodiments of the present technology are not limited to the example tiles of FIG. 2. In one embodiment, the tiles are displayed on a display.

At 708 of FIG. 7, it is determined whether there is an interaction with a tile of the plurality of tiles. In one embodiment, an interaction is a cursor controlled by a user interface interaction device (e.g., a mouse) being placed (e.g., hovering) over the tile. In another embodiment, a user interacts with a tile by placing the cursor over the tile and pressing a button (e.g., clicking or single-clicking) on the user interface interaction device.

In one embodiment, as shown at 710 of FIG. 7, if it is determined that there is not an interaction with a tile, static content is rendered within the tile. For example, a tile that is not subjected to interaction displays an image, such as a movie poster, an advertisement, a logo, or a textual description. In one embodiment, the static content is one frame of dynamic content, e.g., video content.

In one embodiment, as shown at 712 of FIG. 7, if it is determined that there is an interaction with a tile, dynamic content is rendered within the tile. As described above, the term dynamic content refers to any content that changes appearance over time. In various embodiments, dynamic content includes, but is not limited to audio content, video content, and audio/video content. For example, dynamic content can include without limitations: movies, movie trailers, commercial advertisements, animation, television programming, music videos, or other dynamic presentations. For example, where the dynamic content includes a movie trailer, an interaction with the tile causes the movie trailer to be played within the tile. In one embodiment, the dynamic content is displayed on a display. In one embodiment, if a cessation of the interaction with the tile is detected, process 700 returns to 710, where static content is rendered within the frame.

In one embodiment, as shown at 714 of FIG. 7, responsive to a second interaction with the tile, an application page is launched. In one embodiment, the second interaction indicates a selection of the tile. For example, with reference to FIG. 2, a user may select tile 206 to launch an application page that allows the user to browse and select various categories of online media content. An example application page 300 is shown in FIG. 3.

In one embodiment, where a user interacts with a tile by placing a cursor controlled by a user interface interaction device over the tile, a user selects the tile by placing the cursor over the tile and pressing a button on the user interface interaction device. In another embodiment, where a user interacts with a tile by placing the cursor over the tile and pressing a button on the user interface interaction device, a user selects the tile by placing the cursor over the tile and pressing the button on the user interface interaction device twice (e.g., double-clicking). It should be appreciated that different ways of interacting with and selecting a tile may be implemented according to various embodiments of the present technology, and that embodiments of the present technology are not limited to the described embodiments.

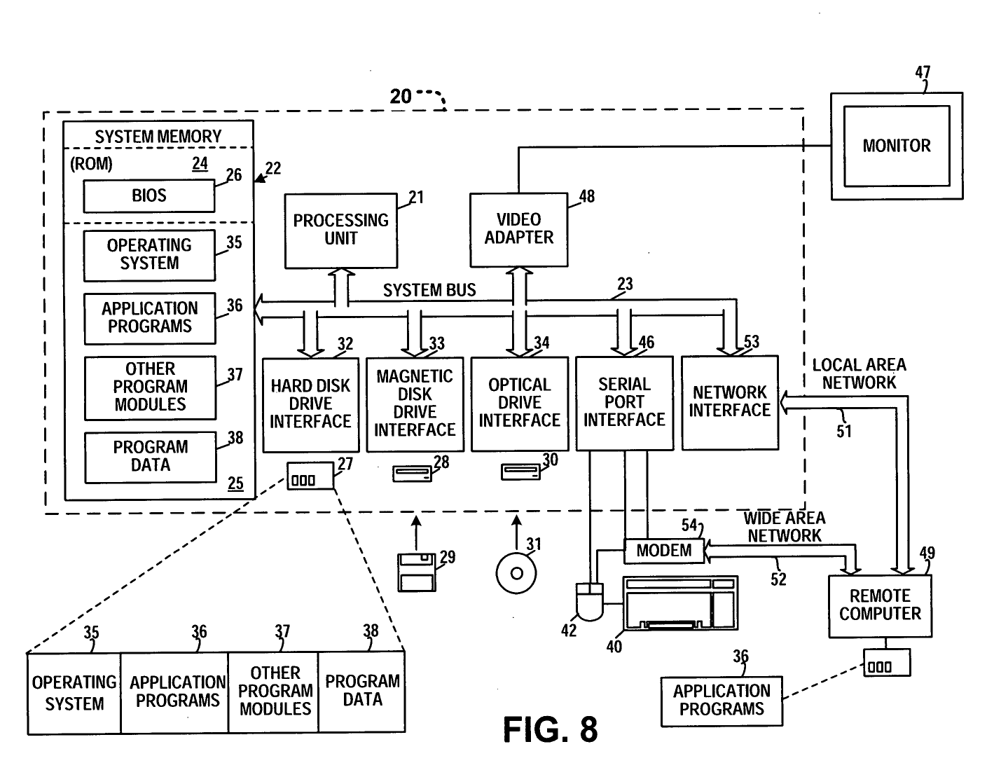

The example hardware and operating environment of FIG. 8 for implementing embodiments of the technology includes a computing device, such as general purpose computing device in the form of a gaming console or computer 20, a mobile telephone, a personal data assistant (PDA), a set top box, or other type of computing device. In the embodiment of FIG. 8, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the embodiments of the technology are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; embodiments of the technology are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example embodiment, a user interface framework module, a download module, a discovery interface module, a library of code components, and other modules may be embodied by instructions stored in memory 22 and/or storage devices 29 or 31 and processed by the processing unit 21. A personal media library, content, databases, markups, packages, resources, and other data may be stored in memory 22 and/or storage devices 29 or 31 as persistent datastores.

Various embodiments of the technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting embodiment is a matter of choice, dependent on the performance requirements of the underlying system implementing the embodiments of the technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the technology. Although various embodiments of the technology have been described above with a certain degree of particularity, or with reference to one or more individual embodiments, those skilled in the art could make numerous alterations to the disclosed embodiments without departing from the spirit or scope of this technology. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the technology as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method of providing dynamic content in a user interface page in an application, the method comprising:
rendering the user interface page in the application, the user interface page comprising at least one menu item;
responsive to a selection of a menu item of the at least one menu items, rendering at least one tile corresponding to the selected menu item;
responsive to an interaction with a tile of the at least one tiles, rendering dynamic content within the tile in the application.

2. The method as recited in claim 1 wherein the interaction comprises a cursor placed over the tile.

3. The method as recited in claim 1 wherein the interaction comprises a single-click selection of the tile.

4. The method as recited in claim 1 further comprising:
responsive to a second interaction with the tile, launching an application page.

5. The method as recited in claim 1 further comprising:
responsive to cessation of the interaction with the tile, rendering static content within the tile in the application.

6. The method as recited in claim 1 wherein the dynamic content comprises a video.

7. The method as recited in claim 1 further comprising accessing resources for rendering within a user interface page of the application, wherein the resources comprise dynamic content.

8. The method as recited in claim 1 wherein the accessing resources for rendering within a user interface page of the application comprises:
accessing a local resource comprising the dynamic content.

9. The method as recited in claim 1 wherein the accessing resources for rendering within a user interface page of the application comprises:
extracting a resource locator identifying an external location comprising the dynamic content; and
accessing the external location comprising the dynamic content.

10. In a computer system having a graphical user interface including a display and a user interface interaction device, a method of providing dynamic content at the graphical user interface in an application, the method comprising:
accessing resources for rendering within a user interface page of the application, wherein the resources comprise dynamic content;
displaying the user interface page on the display, the user interface page comprising a plurality of menu items;
receiving a selection of a menu item of the plurality of menu items, and, in response to the selection, displaying a plurality of tiles corresponding to the selected menu item;
receiving an interaction with a tile of the plurality of tiles, and, in response to the interaction, displaying dynamic content within the tile in the application.

11. The method as recited in claim 10 wherein the interaction comprises a cursor controlled by the user interface interaction device hovering over the tile.

12. The method as recited in claim 10 wherein the interaction comprises a single-click selection of the tile by the user interface interaction device.

13. The method as recited in claim 10 further comprising:
receiving a second interaction with the tile, and, in response to the second interaction, launching an application page.

14. The method as recited in claim 10 further comprising:
detecting a cessation of the interaction with the tile, and, in response to detecting the cessation, rendering static content within the tile in the application.

15. The method as recited in claim 10 wherein the dynamic content comprises a video.

16. The method as recited in claim 10 wherein the accessing resources for rendering within a user interface page of the application comprises:
accessing a local resource comprising the dynamic content.

17. The method as recited in claim 10 wherein the accessing resources for rendering within a user interface page of the application comprises:
extracting a resource locator identifying an external location comprising the dynamic content; and
accessing the external location comprising the dynamic content.

18. Instructions on a computer-usable medium wherein the instructions when executed cause a computer system to perform a method for providing dynamic content in a user interface page in an application, the computer-implemented method comprising:
rendering the user interface page in the application, the user interface page comprising a plurality of menu items;
responsive to a selection of a menu item of the plurality of menu items, rendering a plurality of tiles corresponding to the selected menu item, wherein the plurality of tiles comprises static images if there is no interaction with the plurality of tiles;
responsive to an interaction with a tile of the plurality of tiles, rendering dynamic content within the tile in the application, wherein said interaction comprises a cursor controlled by a user interface interaction device hovering over the tile.

19. The computer-usable medium of claim 18, wherein the rendering the user interface page in the application comprises:
accessing a local resource comprising the dynamic content.

20. The computer-usable medium of claim 18, wherein the rendering the user interface page in the application comprises:
extracting a resource locator identifying an external location comprising the dynamic content; and
accessing the external location comprising the dynamic content.
